(19) United States
(12) Patent Application Publication
(10) Pub. No.: US 2026/0030048 A1
(43) Pub. Date: Jan. 29, 2026

(54) RESOURCE DETERMINATION DEVICE, METHOD, AND PROGRAM

(71) Applicant: NIPPON TELEGRAPH AND TELEPHONE CORPORATION, Tokyo (JP)

(72) Inventors: Chao WU, Musashino-shi (JP); Shingo HORIUCHI, Musashino-shi (JP); Hiroaki KIKUSHIMA, Musashino-shi (JP)

(73) Assignee: NIPPON TELEGRAPH AND TELEPHONE CORPORATION, Tokyo (JP)

(21) Appl. No.: 18/997,901

(22) PCT Filed: Jul. 27, 2022
(86) PCT No.: PCT/JP2022/028965

§ 371 Date: Jan. 23, 2025

(51) Int. Cl. G06F 9/455

(52) U.S. Cl. CPC G06F 9/45558; G06F 2009/4557; G06F 2009/45579

(57) ABSTRACT

According to a resource determination device in an embodiment, categorization information indicating that a plurality of processing loads with similar sizes, arrangement of which in virtual machines has been requested, are categorized into each of a plurality of categories to which priority orders have been applied is stored, a processing load categorized in any of the categories is extracted in accordance with the priority orders, and when a predicted value of quality when it is assumed that the processing load has been arranged in the virtual machine does not satisfy a requirement for appropriate quality, a processing load categorized into a same category as a category into which the processing load used for the determination belongs is not extracted, a processing load categorized into a category with a lower priority order or the same category is extracted, and whether or not the predicted value satisfies the requirement is determined again.

### TECHNICAL FIELD

Embodiments of the present invention relate to a resource determination device, a method, and a program.

### BACKGROUND ART

In order to satisfy user experience quality requirements of services, optimal control techniques of resources of server computers have been studied. In order to satisfy user experience quality requirements of web meetings when the techniques are applied to web meeting services, it is necessary to appropriately arrange web meetings as processing loads for each instance, for example, each virtual machine (VM), that is, it is necessary to perform so-called sorting-out of web meetings, by adding or reducing cloud instances in which the web meeting servers are to be accommodated in a virtual space in accordance with reservation information of the web meetings.

### CITATION LIST

### Patent Literature

Patent Literature 1: JP 2020-72327 A

### SUMMARY OF INVENTION

### Technical Problem

On the other hand, when instances as sorting destination of the web meetings are determined as described above, it is necessary to calculate all combinations of the web meetings based on reservation of existing web meetings and new web meetings, to input the combinations to a performance inference model, and to determine whether or not user experience quality requirements are satisfied. However, since the number of combinations of the web meetings suddenly increases and the calculation time required to make the above determination increases as the number of web meetings increases, it is not possible to apply this to an actual operation.

The present invention was made by focusing on the above circumstances, and an object thereof is to provide a resource determination device, a method, and a program that are adapted to enable calculation related to arrangement of processing loads in instances to be reduced.

### Solution to Problem

A resource determination device according to an aspect of the present invention includes: a model storage device that stores a model indicating relationships of processing loads arranged in virtual machines, resource arrangement of the virtual machines, and a predicted value of quality when the processing loads are arranged in the virtual machines; a categorization information storage device that stores categorization information indicating that one processing load or a plurality of processing loads with similar load sizes, arrangement of which in the virtual machines has been requested, are categorized into each of a plurality of categories to which priority orders are applied; a determination unit that extracts a processing load categorized into any of the plurality of categories in accordance with the priority orders and determines whether or not the predicted value of the quality when it is assumed that the processing load has been arranged in the virtual machine in the model satisfies a requirement for appropriate quality; and a control unit that is adapted such that when the determination unit determines that the predicted value satisfies the requirement for the appropriate quality, the control unit controls a change in resource arrangement of the virtual machines such that the processing load used for the determination is arranged in the virtual machine used for the determination, wherein the determination unit does not extract a processing load categorized into a same category as a category into which a processing load used for determination is categorized when it is determined that the predicted value does not satisfy the requirement for the appropriate quality, extracts a processing load categorized into a category with a lower priority order than a priority order applied to a category into which the processing load used for the determination is categorized or the processing load categorized into the same category as the category into which the processing load used for the determination is categorized, and determines again whether or not the predicted value of the quality when it is assumed that the processing load has been arranged in the virtual machine in the model satisfies the requirement for the appropriate quality.

A resource determination method according to an aspect of the present invention is a method performed by a resource determination device including a model storage device that stores a model indicating relationships of processing loads arranged in virtual machines, resource arrangement of the virtual machines, and a predicted value of quality when the processing loads are arranged in the virtual machines, and a categorization information storage device that stores categorization information indicating that one processing load or a plurality of processing loads with similar load sizes, arrangement of which in the virtual machines has been requested, are categorized into each of a plurality of categories to which priority orders are applied, the method including; by a determination unit of the resource determination device, extracting a processing load categorized into any of the plurality of categories in accordance with the priority orders and determining whether or not the predicted value of the quality when it is assumed that the processing load has been arranged in the virtual machine in the model satisfies a requirement for appropriate quality; and when the determination unit determines that the predicted value satisfies the requirement for the appropriate quality, controlling, by a control unit of the resource determination device, a change in resource arrangement of. the virtual machines such that the processing load used for the determination is arranged in the virtual machine used for the determination, wherein the determination unit does not extract a processing load categorized into a same category as a category into which a processing load used for determination is categorized when it is determined that the predicted value does not satisfy the requirement for the appropriate quality, extracts a processing load categorized into a category with a lower priority order than a priority order applied to a category into which the processing load used for the determination is categorized or the processing load categorized into the same category as the category into which the processing load used for the determination is categorized, and determines again whether or not the predicted value of the quality when it is assumed that the processing load has been arranged in the virtual machine in the model satisfies the requirement for the appropriate quality.

### ADVANTAGEOUS EFFECTS OF INVENTION

According to the present invention, it is possible to reduce calculation related to arrangement of processing loads in instances.

### BRIEF DESCRIPTION OF DRAWINGS

FIG. 1 is a diagram illustrating an application example of a resource determination system according to an embodiment of the present invention.

FIG. 2 is a diagram illustrating an example of input/output data of a web meeting quality model.

FIG. 3A is a flowchart illustrating an example of a processing procedure related to disposition of a web meeting performed by the resource determination device according to the embodiment of the present invention.

FIG. 3B is a flowchart illustrating an example of the processing procedure related to disposition of a web meeting performed by the resource determination device according to the embodiment of the present invention.

FIG. 4 is a diagram illustrating an example of a web meeting categorized into a category.

FIG. 5 is a diagram illustrating a specific example of a horizontal scale in accordance with web meeting quality.

FIG. 6 is a diagram illustrating a specific example of the horizontal scale in accordance with web meeting quality.

FIG. 7 is a diagram illustrating, in a table format, an example of numbers of combinations of web meetings used for calculation related to arrangement of web meetings.

FIG. 8 is a block diagram illustrating an example of a hardware configuration of a resource determination device according to an embodiment of the present invention.

### DESCRIPTION OF EMBODIMENTS

Hereinafter, an embodiment according to the present invention will be described with reference to the drawings.

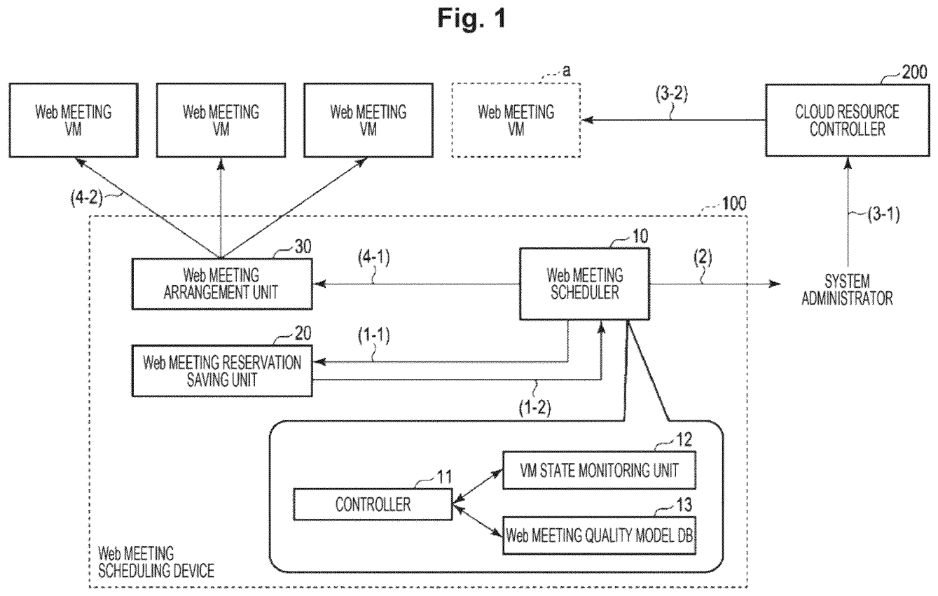

FIG. 1 is a diagram illustrating an application example of a resource determination system according to an embodiment of the present invention.

As illustrated in FIG. 1, the resource determination system according to the embodiment of the present invention includes a web meeting scheduling device 100 that is a resource determination device and & cloud resource controller 200.

The web meeting scheduling device 100 includes a web meeting scheduler 10, a web meeting reservation saving unit 20, and a web meeting arrangement unit 30. Further, the web meeting scheduler 10 includes a controller (determination unit, control unit) 11, an instance (VM) state monitoring unit 12, and a web meeting quality model database (DB) 13.

Web meeting information indicating content of web meetings that have already been booked and have not yet been finished is saved in a database, which is not illustrated, in the web meeting reservation saving unit 20.

The web meetings that have already been booked and have not yet been finished include web meetings that have been arranged in the VMs and are currently being held and web meetings that have not yet begun and arrangement of which in the VMs has been requested.

Information regarding the web meetings that are being held includes, for example, (1) identification information (an identifier, ID) applied to each piece of web meeting information and (2) processing loads related to the web meetings to be arranged in the VMs (hereinafter, referred to as web meeting loads in some cases), for example, information regarding the numbers of participants of the booked web meetings and time zones in which the web meetings are scheduled to be carried out.

Information regarding the web meetings, arrangement of which in the VMs has been requested, so-called reservation information, includes, for example, (1) identification information (ID) applied to each piece of reservation information and (2) processing loads related to the web meetings to be arranged in the VMs (hereinafter, referred to as web meeting loads in some cases), for example, information regarding the numbers of scheduled participants in the booked web meetings and time zones in which the web meetings are scheduled to be carried out, Information regarding finished web meetings is deleted from the web meeting reservation saving unit 20.

A user who desires to book a new web meeting can transmit a request for booking a web meeting to the web meeting scheduler 10 by using an interface which can be connected to the web meeting scheduler 10 and is not illustrated in the drawing.

Once the reservation request is received, the web meeting scheduler 10 saves the reservation information related to the request in the web meeting reservation saving unit 20 ((1-1) in FIG. 1) and acquires reservation information including the saved reservation information and. indicating reservation content of web meetings that have been booked and have not yet been finished ((1-2) in FIG. 1). This reservation information indicates processing loads (hereinafter, referred to as web meeting loads in some cases) related to the web meetings arranged in the VM, for example, information related to the numbers of participants in the web meetings and scheduled opening time zones.

Once the above reservation information is acquired, the controller 11 of the web meeting scheduler 10 makes an inquiry to the instance state monitoring unit 12 for a state of each VM, which is an instance used for the web meetings, for example, a resource setting condition in the VMs in which the web meetings are arranged, for example, the number of cores of a central processing unit (CPU) and memory capacity, and acquires information indicating the inquired state. Here, it is assumed that each VM is a virtual machine operated on a cloud.

The controller 11 inputs the information acquired from the instance state monitoring unit 12 to the web meeting quality model in the web meeting quality model DB 13. The web meeting quality model can receive, as inputs, (1) resource setting conditions in the VMs in which the web meetings are arranged and (2) information indicating processing loads related to the web meetings that are currently arranged in VMs and the web meetings assumed to be arranged in the VMs and output predicted values of user experience quality related to the web meetings arranged in the VMs, and relationships between the inputs and the outputs may be learned in advance.

When the predicted values of the user experience quality output from the web meeting quality model do not satisfy predetermined conditions for user experience quality, the controller 11 recommends, to the system administrator, adjustment of resources of VMs where the web meetings are to be arranged in order for the user experience quality to satisfy the above condition as needed ((2) in FIG. 1).

At the same time, the controller 11 instructs the web meeting arrangement unit 30 to arrange the web meetings in VMs which are arrangement destinations of the web meetings such that the user experience quality satisfies the above condition ((4-1) in FIG. 1).

The system administrator provides an instruction related to resource adjustment by operating the cloud resource controller 200 ((3-1) in FIG. 1).

In response to this instruction, the cloud resource controller 200 can start a new VM (see the reference sign a in FIG. 1) in which the web meeting is to be arranged and change resources of this VM ((3-2) in FIG. 1).

In response to the above instruction, the web meeting arrangement unit 30 arranges the web meetings in the VMs such that the web meetings can be started ((4-2) in FIG. 1).

Next, a configuration of the web meeting quality model and learning thereof will be described.

The controller 11 of the web meeting scheduler 10 acquires, from the instance state monitoring unit 12, (1) web meeting loads which are processing loads related to the web meetings arranged in the VMs and the web meetings that are assumed to be arranged in the VMs and (2) cloud resource settings which are resource setting conditions in the VMs in which the web meetings are to be arranged, and inputs the acquisition results as explanatory variables to the web meeting quality model.

The above processing loads related to the web meetings are, for example, the numbers of web meetings, the numbers of participants in the web meetings, the numbers of publishers who are participating in the web meetings, and the numbers of subscribers.

The above resource setting conditions are, for example, the numbers of CPUs and the amounts of memory provided in the VMs that are instances.

The web meeting quality model can output, as object variables, indexes representing quality of the web meetings, that is, user experience quality, in other words, predicted values of the quality of the web meetings on the basis of the results of the above inputs. Parameters of the model can be learned such that relationships between inputs and outputs become appropriate, that is, such that the predicted values of the quality of the web meetings approach correct answer information using a regression analysis method, for example, neural-network regression, linear regression, or random forest regression.

For example, examples of the indexes representing the quality of web meetings include predicted values of CPU use rates in the VMs that are instances where the web meetings are arranged and predicted values of jitters, throughputs, and mean opinion scores (MOS).

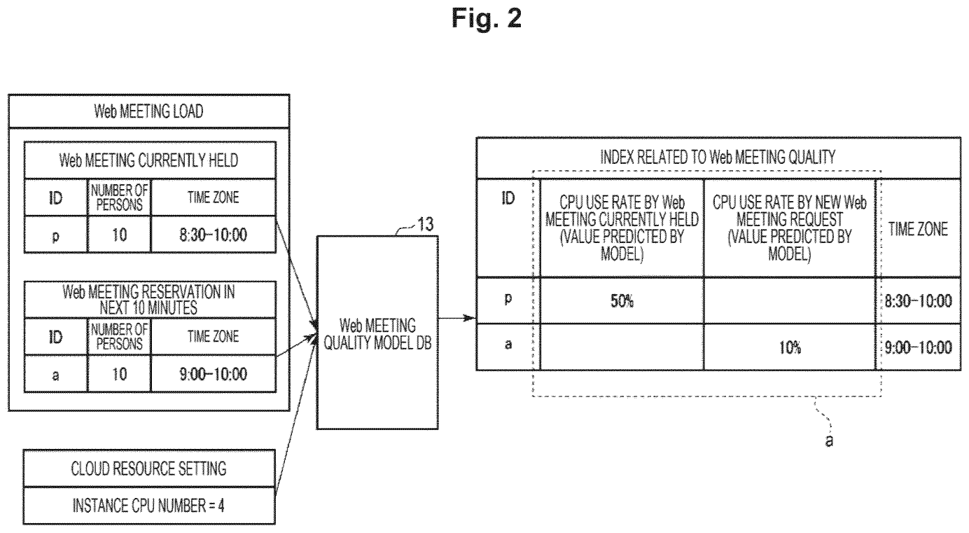

Next, calculation of the indexes regarding web meeting quality using the web meeting quality model trained as described above will be described. FIG. 2 is a diagram illustrating an example of input/output data of the web meeting quality model. Here, it is indicated that user experience quality is calculated according to reservation of a new web meeting,

In the example illustrated in FIG. 2, the web meeting loads indicated by the information to be input to the web meeting model include (1) web meeting loads related to web meetings that are currently in progress (also referred to as web meetings that are currently being held) and (2) web meeting loads related to web meeting reservations for 10 minutes in the future, which are reservations of web meetings that are to be started in 10 minutes from the current clock time in accordance with new web meeting requests (see the reference sign a in FIG. 2). 10 minutes, which is the time from the current time to the scheduled start time related to the web meeting reservation for 10 minutes in the future, can be customized according to the actual operation state of the instance.

The web meeting loads related to the web meetings that are currently in progress described above may include identification information (IDs) that uniquely identify the corresponding web meetings, the numbers of participants in the corresponding web meetings, and the time zones from start clock times to end clock times of the corresponding web meetings.

The aforementioned web meeting loads related to the web meeting reservations for 10 minutes in the future may include identification information that uniquely identifies the corresponding web meetings, the numbers of scheduled participants in the corresponding web meetings, and time zones from start scheduled clock times to end scheduled clock times of the corresponding web meetings.

The cloud resource setting input to the web meeting model described above may include the number of CPUs mounted in one VM that is an instance. The above web meetings that are currently in progress are arranged in the one VM.

The above indexes related to the quality of the web meetings output from the web meeting model may include identification information that uniquely identifies the corresponding web meetings, a predicted value of a use rate of a CPU in the one VM due to the web meetings that are currently in progress, a predicted value of a use rate of. the CPU in the one VM due to the web meetings that will be held in response to new meeting requests, and a time zone from a start to an end of each of the web meetings.

In the example illustrated in FIG. 2, the predicted value of the use rate of the CPU in the VM when a “web meeting p” with the identification information “p” has been arranged in the one VM is 50%.

In addition, in the example illustrated in FIG. 2, when it is assumed that “web meeting a” having identification information “a” is newly arranged for the one VM, a predicted value of the CPU use rate of the VM is 10%.

This “web meeting a” is a web meeting for which holding in a time zone partially overlapping with the time zone of the “web meeting p” has been newly requested.

When a threshold value of the use rate of the CPU in the one VM is set to 80%, the sum of the predicted values of the use rates of the CPU on the assumption that a “web meeting a” has newly been arranged in addition to the “web meeting p” in the VM is 60% and does not exceeds the threshold value 80%, and it is thus possible to arrange the “web meeting a” in the one VM in which the “web meeting p” is currently arranged.

On the other hand, when the predicted value of the use rate of the CPU in the corresponding VM when it is assumed that the ‘web meeting a″ has newly been arranged exceeds, for example, 30%, the sum of the predicted values exceeds the threshold value, and it is necessary to adjust the types of the web meetings to be arranged in the VM or to adjust resources related to the VMs as arrangement destinations.

In the present embodiment, it is assumed that categorization information regarding which of a plurality of virtual bins (bottles) (categories (which may also be referred to as groups)) with individual priority orders applied thereto each of a plurality of new web meetings, arrangement of which in the VMs has been requested, is to be categorized is defined in advance, and when the plurality of new web meetings are arranged (sorted out) to the VMs, a plurality of web meetings with similar sizes based on the sizes as processing loads, for example, the numbers of participants in the web meetings, probabilities at which camera or sound input/output function is validated, and the like are categorized into the same bins, and categorization information indicating the categorization is stored in the web meeting reservation saving unit 20 in advance.

It is desirable that a higher priority order be applied to each of the plurality of bins as the size of the web meeting to be categorized as a processing load increases, for example.

Also, in the present embodiment, the resource determination system extracts one representative web meeting from one bin selected in the descending order of the priority order applied to the bins, inputs a combination of a web meeting that is currently in progress or a so-called existing web meeting and the web meeting extracted from the bin to the web meeting model, and determines whether or not an index related to quality of the web meeting that is an output result from the web meeting model satisfies a requirement for user experience quality, that is, a requirement of the use rate of the CPU in the VM that is an arrangement destination of the web meetings related to the above combination, for example.

When the above requirement is satisfied, the resource determination system selects the extracted new web meeting related to the determination as a web meeting to be newly arranged in the VM, extracts a different web meeting categorized into the same bin, and performs determination as described above thereon.

In a case where the above requirement is not satisfied, the resource determination system does not regard the different web meeting categorized into the same bin as a target of extraction and regards, as a target of. extraction, a web meeting from a bin to which the next priority order, that is, a lower priority order than the priority order of the right previous bin that is the extraction source of the web meeting has been applied. Then, the above determination is repeated until the determination related to the web meeting categorized into the bin to which the last priority order has been applied ends.

It is possible to significantly reduce the number of combinations of the web meetings to be input to the web meeting model and to reduce a calculation time and resources needed to sort out new web meeting models to the VMs by the above method.

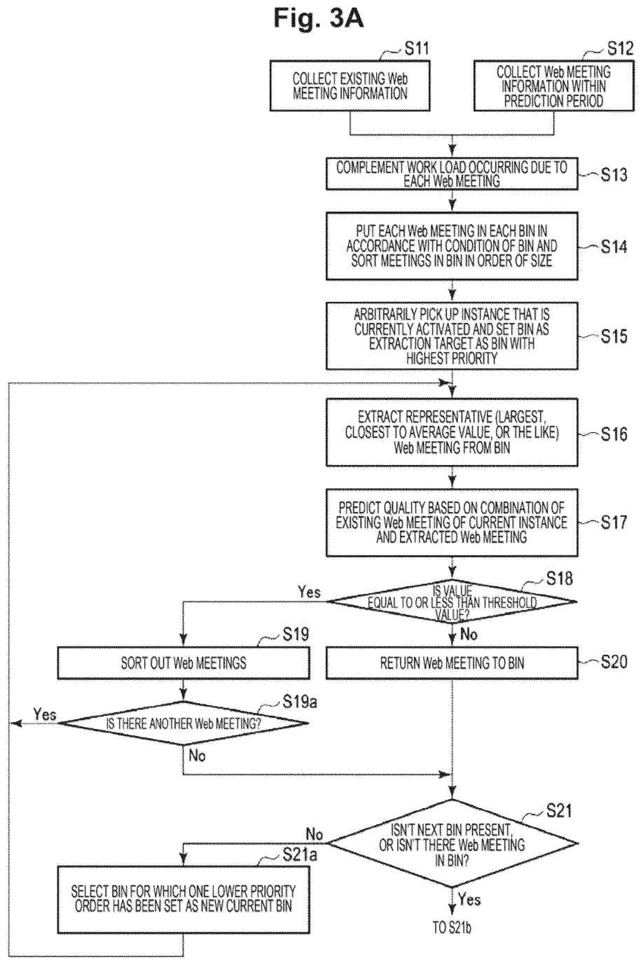

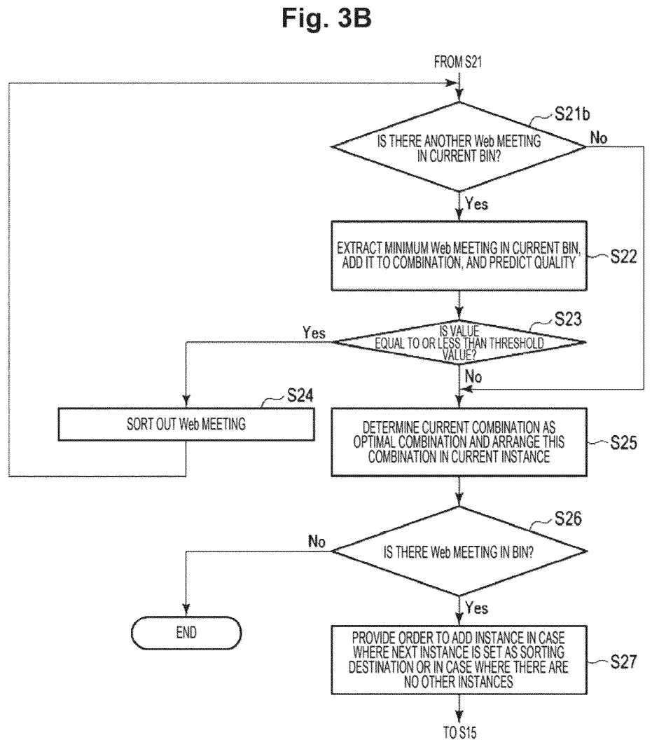

FIGS. 3A and 38 are flowcharts illustrating an example of a processing procedure related to arrangement of web meetings performed by the resource determination device according to the embodiment of the present invention.

First, the controller 11 of the web meeting scheduler reads and thereby collects (1) information related to existing web meetings, that is, web meetings that are currently in progress and (2) information related to web meetings within a predicted period from the web meeting reservation saving unit 20 (S11, S12). The above prediction period is, for example, a period including overlapping periods between opening scheduled times of the existing web meetings and opening scheduled periods of the above requested web meetings.

Next, the controller 11 reads and thereby collects information complementing workloads generated when each of the web meetings is arranged in the VM from the web meeting reservation saving unit 20 (S13). The complementing information is, for example, the number of sessions of videos when a target web meeting is arranged in the VM.

Next, the controller 11 categorizes each of the requested web meetings into each bin (which may be referred to as “put into the bin”) in accordance with conditions of each bin (category) on the basis of the collection results in S12 and S13. Here, in a case where a plurality of web meetings are categorized in one bin, each of the web meetings in the bin is sorted in the order of the sizes of processing loads related to the web meetings (S14). S11 to S14 correspond to initial processing prior to the sorting-out of the web meetings to the VMs.

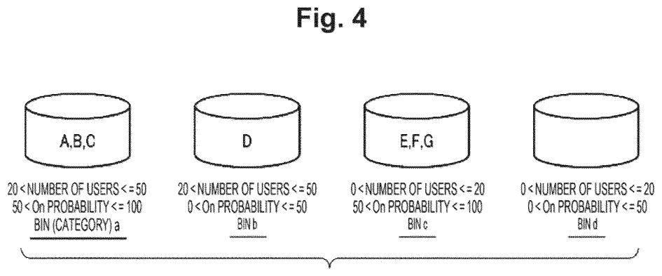

FIG. 4 is a diagram illustrating an example of the web meetings categorized into categories.

FIG. 4 shows four types of bins, that is, a bin a, a bin b, a bin c, and a bin d. In regard to these bins, conditions of processing loads related to the web meetings put into the bins, here, the number of users and a probability at which input and output functions of videos or the like are validated, that is, an On probability are individually set for each bin. For example, conditions of processing loads related to web meetings to be put into the bin a illustrated in FIG. 4 are a condition that the number of participants, that is, the number of users is greater than twenty and equal to or less than 50 and a condition that a probability at which the video input and output function is validated is greater than 50% and equal to or less than 100%. It is possible to categorize web meeting into the bin a under these conditions.

In the example illustrated in FIG. 4, web meetings, arrangement of which in a certain VM has been requested, are a meeting A, a meeting B, a meeting C, a meeting D, a meeting E, a meeting F, and a meeting G. Here, the processing load when each of the web meetings is arranged in the VM decreases in the order of the meeting A, the meeting B, the meeting C, the meeting D, the meeting E, the meeting F, and the meeting G. Also, a processing load when each of the web meetings is arranged in the VM are similar among the meeting A, the meeting B, and the meeting C and are also similar among the meeting E, the meeting F, and the meeting G.

The meeting A, the meeting B, and the meeting C with similar processing loads when they are arranged in the VM are categorized into the bin a and are sorted in the order of the meeting A, the meeting B, and the meeting C, The meeting D that obviously has a lower processing load when it is arranged in a VM than all of the meeting A, the meeting B, and the meeting C is categorized into the bin b, and the meeting E, the meeting F, and the meeting G with similar processing loads when they are arranged in a VM are categorized into the bin c and are sorted in the order of the meeting E, the meeting F, and the meeting G. Also, it is assumed that no web meetings are arranged in the bin d.

The processing load when the meeting E is arranged in the VM, the processing load when the meeting F is arranged in the VM, and the processing load when the meeting G is arranged in the VM are obviously lower than the processing load when the meeting D is arranged in the VM.

The priority orders related to sorting-out of the requested web meetings, that is, priority levels are set for these bins a to d in accordance with how high/low the processing loads related to the web meetings to be categorized are, for example, the conditions of the processing loads related to the web meetings to be put into the bins described above. In other words, relatively high priority orders are set for bins for relatively high processing loads related to the categorized web meetings, and relatively low priority orders are set for bins for relatively low processing loads related to the categorized web meetings.

Here, the highest priority order is set for the bin a, and priority orders that decrease one by one are set for the bin b, the bin c, and the bin d in this order. In other words, the lowest priority order is set for the bin d.

Next, the controller 11 picks up an arbitrary one of the plurality of VMs that are currently activated instances as a candidate for an arrangement destination of the above requested web meetings, that is, as an instance of a current arrangement destination (referred to as a current instance in some cases) on the basis of the maximum use rate and the minimum use rate and the like of the resources in the instances and selects the bin with the highest priority order from among the above bins as a bin that is a current processing target (referred to as a current bin in some cases) (S15).

When a plurality of web meetings are categorized in the current bins selected in S15, the controller 11 extracts, from the web meeting reservation saving unit 20, information related to a representative web meeting from among the web meetings before sorting-out, which will be described later, of these web meetings. Also, when one web meeting has been categorized in the current bin selected in S15, the controller 11 extracts information related to the web meeting from the web meeting reservation saving unit 20 (S16). Examples of the above representative web meeting include a web meeting with the largest processing load from among web meetings categorized into the same bin and a web meeting with the processing load that is the closest to an average value of the processing loads of the web meetings categorized into the same bin.

The controller 11 acquires a predicted value of the user experience quality related to the web meetings arranged in the current VM by inputting, to the web meeting quality model, a combination of (1) information related to the web meetings arranged in the VM that is the current instance picked up as described above (referred to as a current VM in some cases) and (2) information related to the web meeting extracted in S16 (S17). The web meetings arranged in the VM that is the current instance picked up as described above includes the existing web meetings collected in S11 and web meetings that have already been sorted out, which will be described later.

The controller 11 determines whether or not the predicted value acquired in S17 is equal to or less than a threshold value, that is, whether or not the predicted value satisfies a predetermined condition of the user experience quality (S18).

When the predicted value acquired in S17 is equal to or less than the threshold value, that is, the predicted value satisfies the predetermined condition of the user experience quality (Yes in S18), the controller 11 sorts out the right previous web meeting extracted in S16 along with the above existing web meetings to a tentative combination of the web meetings arranged in the VM that is the current instance (S19). After S19, if web meetings before sorting out to the instance remains in the current bin selected in S15 (Yes in S19a), the processing in and after S16 is performed on the remaining web meetings in the current bin before the sorting out.

On the other hand, when the predicted value acquired in S17 is greater than the threshold valve, that is, when the predicted value does not satisfy the predetermined condition of the user experience quality (No in S18), the controller 11 returns the right previous web meeting extracted in S16 to the original bin (S20).

Also, after S19 and when no web meetings before the sorting-out to the instance remains in the current bin selected in S15 (No in S19a), or after S20 and in a case where there is a bin (referred to as a next bin in some cases) for which one lower priority order than the priority order applied to the current bin selected in S15 has been set and the web meetings before sorting out to the instance are categorized into the bin for which the one lower priority order has been set (No in S21), the controller 11 selects the bin for which the one lower priority order has been set as a new current bin (S21a), and the processing in and after S16 is performed on the web meetings categorized into the bin.

On the other hand, in a case where the bin for which the lower priority order than the priority order applied to the current bin selected in S15 has been set, that is, the next bin is not present, or in a case where although the next bin is present, no web meetings have been categorized into the next bin (Yes in S21), the controller 11 determines whether or not different web meetings before sorting-out other than the right previous web meeting extracted in S16 have been categorized into the current bin selected in S15 (S21b).

When the above web meetings before the sorting-out have been categorized into the current bin (Yes in S21b), information related to a web meeting with the minimum processing load when it is arranged in the current VM is extracted from the web meeting reservation saving unit 20. The controller 11 acquires the predicted value of the user experience quality related to the web meetings arranged in the current VM by inputting the combination of the web meeting, the web meetings that have already been sorted out, and the above existing web meetings to the web meeting quality model (S22).

The controller 11 determines whether or not the predicted value acquired in S22 is equal to or less than a threshold value, that is, whether or not the predicted value satisfies a predetermined condition of the user experience quality (S23).

When the predicted value acquired in S22 is equal to or less than the threshold value, that is, when the predicted value satisfies the predetermined condition of the user experience quality (Yes in S23), the controller 11 sorts out the right previous web meeting extracted in S16 along with the above existing web meetings to the tentative combination of the web meetings arranged in the VM which is 20 the current instance (S24). After S24, the processing returns to S21b.

On the other hand, when the predicted value acquired in S22 is greater than the threshold valve (No in S23), or when different web meetings before the sorting-out other than the right previous web meeting extracted in S16 have not been categorized into the current bin selected in S15 (No in S21b), the controller 11 determines, as an optimal combination of the web meetings to be arranged in the VM that is the current instance, the tentative combination of the web meetings to be arranged in the VM that is the current instance, that is, the combination of the existing web meetings acquired in S11 and the web meetings sorted out to the VM that is the current instance in S19 or S24 and arranges the combination in the current instance (S25).

Next, when there are no different web meetings before the extraction is made in the current bin selected in S15 (No in S26), the series of processing ends.

On the other hand, after S25 and when there are another web meetings before the extraction is made in the current bin selected in S15 (Yes in S26), the controller 11 picks up one VM that is a different instance and is not the instance selected in S15 as a new candidate for the arrangement destination of the requested web meetings.

Also, when there are no other instances, addition of instances is determined (S27). Then, the processing in and after Sis is performed on the newly picked-up or added instance.

Next, a specific example of the sorting-out of web meetings according to the present embodiment will be described.

Here, the instance that is currently activated is an “instance A”, the existing web meetings that have already been arranged in the instance A are an existing meeting X and an existing meeting Y, and web meetings, arrangement of which in the instance A has been requested, are meetings A, B, C, D, E, F, and G illustrated in FIG. 4. Also, it is assumed that these meetings are categorized into any of the bins a to d as illustrated in FIG. 4.
1. First, processing corresponding to S11 to S14 described above is performed as initial processing.
2. Next, the controller 11 picks up the instance A as a sorting-out destination of the meetings A, B, C, D, E, and F.
3. Next, the controller 11 extracts the meeting A from the bin a with the highest priority order, predicts user experience quality with a combination of meetings (X, Y, A) with the existing “meeting x”, and when the prediction result is equal to or less than a threshold value, puts the meeting A into a combination of meetings to be arranged in the instance A.
4. Next, the controller 11 extracts the meeting B from the bin a, predicts user experience quality with a combination of the meetings (X, Y, A, B), returns the meeting B to the bin a since the prediction result exceeds the threshold value, and changes the extraction destination of meetings to the bin b.
5. The controller 11 extracts the meeting D from the bin b, predicts user experience quality with a combination of meetings (X, Y, A, D), returns the meeting D to the bin b since the prediction result exceeds the threshold value, and changes the extraction destination of meetings to the bin c.
6. The controller 11 extracts the meeting E from the bin c, predicts user experience quality with a combination of meetings (X, Y, A, E) and returns the meeting E to the bin c since the prediction result exceeds the threshold value.
7. Since the bin c is the bin into which the last meetings of all are to be categorized, the controller 11 extracts the meeting G with the minimum load size that is to be categorized into the bin c, predicts user experience quality with a combination of meetings (X, Y, A, G), returns the meeting G to the bin c since the prediction result exceeds the threshold value, determines the meeting (X, Y, A) in “3.” above as an optimal combination of the meetings to be arranged in the instance A, and arranges the meeting A in the instance A,

Here, since meetings that have not yet been arranged in the instance remain in some of the bins, the controller 11 picks up another instance that is not the instance A as a sorting-out destination.

Also, in a case where there are no other instances at present, the controller 11 determines addition of another instance, for example, the instance B, and performs calculation related to sorting-out of the above meetings that have not yet been arranged for the instance. The calculation is repeated until the instances as the arrangement destination of the all the requested meetings are determined.

Next, an addition example of the above instance will be described.

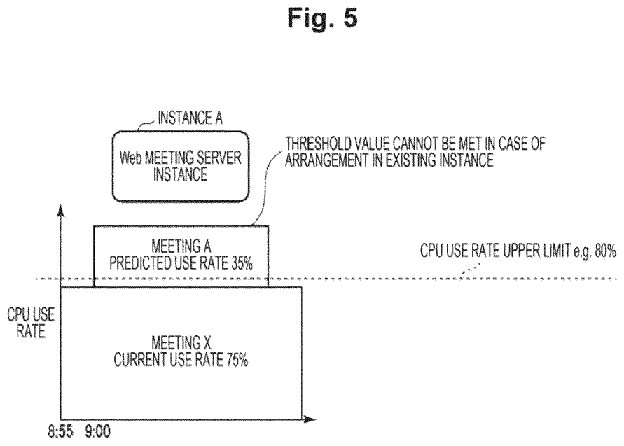

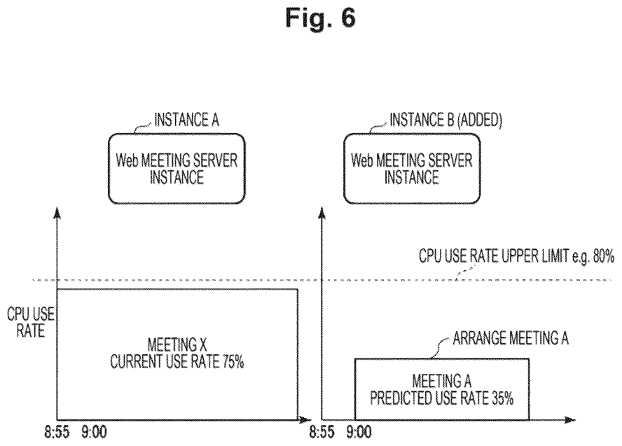

FIGS. 5 and 6 are diagrams illustrating specific examples of a horizontal scale in accordance with web meeting quality.

First, in the example illustrated in FIG. 5, an example in which a prediction value of a current CPU use rate of an existing web meeting “meeting X” arranged from 8:55 in a VM that is an “instance A” which is an existing instance is 75% and an upper limit of the CPU use rate of the VM is 80% is illustrated.

In the example illustrated in FIG. 5, it is assumed that arrangement of a new web meeting “meeting A” starting at 9:00 is requested, and a predicted value of the CPU use rate which increases when it is assumed that this “meeting A” is newly arranged in “instance A” is 35%.

In this case, the overall CPU use rate when it is assumed that the “meeting A” has newly been arranged in the “instance A” is 110% and exceeds the upper limit which is 80%, and scale-out is thus required since an increase in horizontal scale related to the “instance A”, here the number of CPU cores is required.

In the example illustrated in FIG. 6, it is assumed that the new “instance B” has been added according to the above scale-out.

In this configuration, it is assumed that a predicted value of the CPU use rate when it is assumed that “meeting A” is newly arranged in a VM corresponding to a new “instance B” instead of the existing “instance A” and this “meeting A” is newly arranged in “instance B” is 35%.

In this case, since the overall CPU use rate of “instant A” when it is assumed that “meeting A” is newly arranged remains at the above-described 75% which does not 10 exceed the upper limit of 80%, “meeting A” is newly arranged in “instance B” and this “meeting A” can be implemented together with the existing web meeting “meeting X” arranged in “instance A”.

Then, according to the above-described Scale-out, a new “instance B” is provided, and the CPU use rates of “instance A” and “instance B” when it is assumed that “meeting A” is newly arranged in this instance have margins with respect to the upper limit, and thus a new web meeting can be arranged in each instance.

Next, calculation of the number of combinations Of web meetings used for calculation when user experience quality is calculated will be described.

When the number of web meetings is n, the number of combinations of web meetings used for the calculation when the user experience quality is calculated in the related art is 2ⁿ.

On the other hand, when the number of web meetings is n as described above, the number of bins is m, and the numbers of web meetings in the respective bins are n₁, n₂, . . . Dₘ, the number of combinations of the web meetings used for the calculation when the user expedience quality is calculated in the present embodiment is represented by Expression (1) below.

$$< ( {n}_{1} + 1 ) * ( {n}_{2} + 1 ) … * ( {n}_{a} + 1 ) < {( ( n / m ) + 1 )}^{m} \qquad Expression ( 1 )$$

(where n₁+n₂ . . . +nₘ=n)

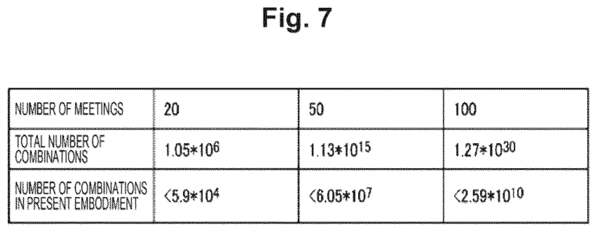

FIG. 7 is a diagram illustrating, in a table format, an example of numbers of combinations of web meetings used for the calculation related to arrangement of the web meetings.

FIG. 7 illustrates a result of comparing the number of combinations of web meetings used for the calculation when the user experience quality is calculated in the related art with the number of combinations of web meetings used for the calculation when the user experience quality is calculated in the present embodiment when the number of bins is ten, and the number of web meetings is twenty, fifty, or one hundred.

As illustrated in FIG. 7, it is possible to significantly reduce the number of combinations used for the calculation when the user experience quality is calculated in the present embodiment than when the user experience quality is calculated for all the combinations of the web meetings as in the related art.

Therefore, it is possible to reduce the calculation related to the arrangement of the processing loads to the instances according to the embodiment of the present invention.

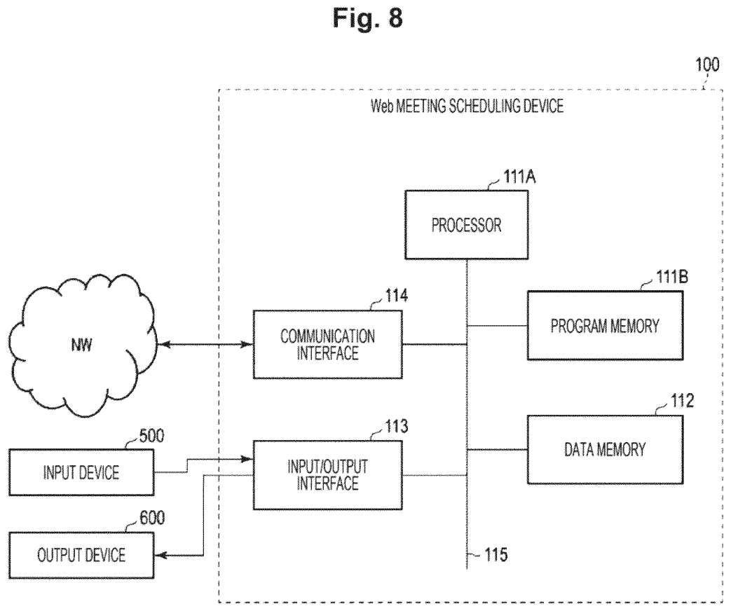

FIG. 8 is a block diagram illustrating an example of a hardware configuration of the resource determination device according to the one embodiment of the present invention.

In the example illustrated in FIG. 8, the web meeting scheduling device 100 according to the above embodiment is configured by, for example, a server computer or a personal computer and includes a hardware processor 111A such as a CPU. Then, the hardware processor 111A is connected to a program memory 1118, a data memory 112, an input/output interface 113, and a communication interface 114 via a bus 115. The same applies to the cloud resource controller 200.

The communication interface 114 includes, for example, one or more wireless communication interface units, and can transmit/receive information to/from a communication network NW. As a wireless interface, for example, an interface is used in which a low-power wireless data communication standard such as a wireless local area network (LAN) is adopted.

An input device 500 and an output device 600, which are attached to the web meeting scheduling device 100 and used by a user or the like, are connected to the input/output interface 113.

The input/output interface 113 takes in operation data input by a user or the like through the input device 500 such as a keyboard, a touch panel, a touchpad, or a mouse, and performs processing of outputting output data to an output device 600 including a display device using liquid crystal, organic electro luminescence (BL), or the like to display the output data. Note that, as the input device 500 and the output device 600, a device built in the web meeting scheduling device 100 may be used, and an input device and an output device of another information terminal that can communicate with the web meeting scheduling device 100 via the network NW may be used.

The program memory 1118 is used as a non-transitory tangible storage medium, for example, as a combination of a non-volatile memory on which writing and reading can be performed as necessary, such as a hard disk drive (HDD) or a solid state drive (SSD), and a non-volatile memory such as a read only memory (ROM), and stores programs necessary for executing various types of control processing and the like according to the one embodiment.

The data memory 112 is used as a tangible storage medium, for example, as a combination of the non-volatile memory and a volatile memory such as a random access memory (RAM) and is used to store various types of data acquired and created in a process in which various types of processing is performed.

The web meeting scheduling device 100 according to an embodiment of the present invention can be configured as a data processing device including a web meeting scheduler 10, the web meeting reservation saving unit 20, and a web meeting arrangement unit 30 illustrated in FIG. 1 as processing function units by software.

Each information storage unit used as a working memory or the like by each component of the web meeting scheduling device 100 may be configured by the data memory 112 illustrated in FIG. 8 being used. However, these configured storage areas are not essential to the web meeting scheduling device 100, and may be, for example, areas provided in an external storage medium such as a Universal Serial Bus (USB) memory or a storage device such as a database server arranged in a cloud.

All of the processing function units in the respective units of the web meeting scheduler 10, the web meeting reservation saving unit 20, and the web meeting arrangement unit 30 can be realized by causing the hardware processor 111A to read and execute a program stored in the program memory 111B. Note that some or all of these processing function units may be implemented in other various forms including an integrated circuit such as an application specific integrated circuit (ASIC) or a field-programmable gate array (FPGA).

In addition, the method described in each embodiment can be stored as a program (software means) that can be executed by a computing machine (computer), for example, in a recording medium such as a magnetic disk (such as a floppy (registered trademark) disk or a hard disk), an optical disc (such as a CD-ROM, a DVD, or a MO), or a semiconductor memory (such as a ROM, a RAM, or a flash memory), and can be distributed by being transmitted through a communication medium. Note that the programs stored in the medium also include a setting program for configuring, in the computing machine, software means (including not only an execution program but also a table and a data structure) to be executed by the computing machine. The computing machine that implements the present device executes the above-described processing by reading the programs recorded in the recording medium, constructing the software means by the setting program as needed, and controlling operation by the software means. Note that the recording medium in the present specification is not limited to a recording medium for distribution, and includes a storage medium such as a magnetic disc or a semiconductor memory provided in an apparatus connected inside a computer or via a network.

Note that the present invention is not limited to the embodiments described above, and various modifications can be made at an implementation stage without departing from the gist of the invention. In addition, the embodiments may be implemented in appropriate combination, and in this case, a combined effect can be obtained. Furthermore, the above embodiments include various inventions, and various inventions can be extracted by a combination selected from a plurality of disclosed components. For example, even if some components are deleted from all the components described in the embodiment, a configuration from which the components have been deleted can be extracted as an invention, as long as the problem can be solved and the effects can be achieved.

REFERENCE SIGNS LIST
100 Web meeting scheduling device
200 Cloud resource controller
10 Web meeting scheduler
11 Controller
12 Instance state monitoring unit
13 Web meeting quality model DB
20 Web meeting reservation saving unit
30 Web meeting arrangement unit

1. A resource determination device comprising:
a model storage device that stores a model indicating relationships of processing loads arranged in virtual machines, resource arrangement of the virtual machines, and a predicted value of quality when the processing loads are arranged in the virtual machines:
a categorization information storage device that stores categorization information indicating that one processing load or a plurality of processing loads with similar load sizes, arrangement of which in the virtual machines has been requested, are categorized into each of a plurality of categories to which priority orders are applied: and
a circuitry configured to:
extract a processing load categorized into any of the plurality of categories in accordance with the priority orders and determines determine whether or not the predicted value of the quality when it is assumed that the processing load has been arranged in the virtual machine in the model satisfies a requirement for appropriate quality: and
when the predicted value satisfies the requirement for the appropriate quality, control a change in resource arrangement of the virtual machines such that the processing load used for the determination is arranged in the virtual machine used for the determination,
wherein the circuitry is configured to:
not extract a processing load categorized into a same category as a category into which a processing load used for determination is categorized when it is determined that the predicted value does not satisfy the requirement for the appropriate quality, extract a processing load categorized into a category with a lower priority order than a priority order applied to a category into which the processing load used for the determination is categorized or the processing load categorized into the same category as the category into which the processing load used for the determination is categorized; and
determine again whether or not the predicted value of the quality when it is assumed that the processing load has been arranged in the virtual machine in the model satisfies the requirement for the appropriate quality.

2. The resource determination device according to claim 1,
wherein when it is determined that the predicted value does not satisfy the requirement for the appropriate quality, and in a case where there is no category with the lower priority order than the priority order applied to the category into which the processing load used for the determination is categorized, or in a case where a processing load that has not yet been used for the determination has not been categorized into the category with the lower priority order, the circuitry is configured to:
extract a minimum processing load, the size of which is minimum, which is categorized into the same category as the category into which the processing load used for the determination is categorized; and
determine whether or not the predicted value of the quality when it is assumed that the processing load has been arranged in the virtual machine in the model satisfies the requirement for the appropriate quality.

3. The resource determination device according to claim 2, wherein the circuitry is configured to;
pick up one virtual machine from among the at least one virtual machine as a candidate virtual machine, which is used for the determination, in which the processing load is to be arranged;
when it is determined that the predicted value when it is determined whether or not the predicted value of the quality when it is assumed that the minimum processing load has been arranged in the virtual machine in the model satisfies the requirement for the appropriate quality does not satisfy the requirement for the appropriate quality, and when processing loads that have not yet been arranged in the virtual machines remain from among the processing loads to be categorized into any of the plurality of categories, pick up another virtual machine again as a candidate virtual machine, which is used for the determination, in which the processing load is to be arranged;
extract any one of the remaining processing loads in accordance with the priority orders; and
determine whether or not the predicted value of the quality when it is assumed that the processing load has been arranged in the virtual machine in the model satisfies the requirement for the appropriate quality.

4. A resource determination method performed by a resource determination device including a model storage device that stores a model indicating relationships of processing loads arranged in virtual machines, resource arrangement of the virtual machines, and a predicted value of quality when the processing loads are arranged in the virtual machines, and a categorization information storage device that stores categorization information indicating that one processing load or a plurality of processing loads with similar load sizes, arrangement of which in the virtual machines has been requested, are categorized into each of a plurality of categories to which priority orders are applied, the method comprising:
extracting a processing load categorized into any of the plurality of categories in accordance with the priority orders and determining whether or not the predicted value of the quality when it is assumed that the processing load has been arranged in the virtual machine in the model satisfies a requirement for appropriate quality:
when it is determined that the predicted value satisfies the requirement for the appropriate quality, controlling a change in resource arrangement of the virtual machines such that the processing load used for the determination is arranged in the virtual machine used for the determination, and
not extracting a processing load categorized into a same category as a category into which a processing load used for determination is categorized when it is determined that the predicted value does not satisfy the requirement for the appropriate quality, extracting a processing load categorized into a category with a lower priority order than a priority order applied to a category into which the processing load used for the determination is categorized or the processing load categorized into the same category as the category into which the processing load used for the determination is categorized, and determines determining again whether or not the predicted value of the quality when it is assumed that the processing load has been arranged in the virtual machine in the model satisfies the requirement for the appropriate quality.

5. The resource determination method according to claim 4,
wherein when it is determined that the predicted value does not satisfy the requirement for the appropriate quality, and in a case where there is no category with the lower priority order than the priority order applied to the category into which the processing load used for the determination is categorized, or in a case where a processing load that has not yet been used for the determination has not been categorized into the category with the lower priority order, extracting a minimum processing load, the size of which is minimum, which is categorized into the same category as the category into which the processing load used for the determination is categorized, and determining whether or not the predicted value of the quality when it is assumed that the processing load has been arranged in the virtual machine in the model satisfies the requirement for the appropriate quality.

6. The resource determination method according to claim 5,
picking up one virtual machine from among the at least one virtual machine as a candidate virtual machine, which is used for the determination, in which the processing load is to be arranged, and
when it is determined that the predicted value when it is determined whether or not the predicted value of the quality when it is assumed that the minimum processing load has been arranged in the virtual machine in the model satisfies the requirement for the appropriate quality does not satisfy the requirement for the appropriate quality, and when processing loads that have not yet been arranged in the virtual machines remain from among the processing loads to be categorized into any of the plurality of categories, picking up another virtual machine again as a candidate virtual machine, which is used for the determination, in which the processing load is to be arranged, extracting any one of the remaining processing loads in accordance with the priority orders, and determining whether or not the predicted value of the quality when it is assumed that the processing load has been arranged in the virtual machine in the model satisfies the requirement for the appropriate quality.

7. A non-transitory computer readable storage medium storing a program, when executed by a resource determination device including a model storage device that stores a model indicating relationships of processing loads arranged in virtual machines, resource arrangement of the virtual machines, and a predicted value of quality when the processing loads are arranged in the virtual machines, and a categorization information storage device that stores categorization information indicating that one processing load or a plurality of processing loads with similar load sizes, arrangement of which in the virtual machines has been requested, are categorized into each of a plurality of categories to which priority orders are applied to provide the steps of
extracting a processing load categorized into any of the plurality of categories in accordance with the priority orders and determining whether or not the predicted value of the quality when it is assumed that the processing load has been arranged in the virtual machine in the model satisfies a requirement for appropriate quality;
when it is determined that the predicted value satisfies the requirement for the appropriate quality, controlling a change in resource arrangement of the virtual machines such that the processing load used for the determination is arranged in the virtual machine used for the determination, and
not extracting a processing load categorized into a same category as a category into which a processing load used for determination is categorized when it is determined that the predicted value does not satisfy the requirement for the appropriate quality, extracting a processing load categorized into a category with a lower priority order than a priority order applied to a category into which the processing load used for the determination is categorized or the processing load categorized into the same category as the category into which the processing load used for the determination is categorized, and determining again whether or not the predicted value of the quality when it is assumed that the processing load has been arranged in the virtual machine in the model satisfies the requirement for the appropriate quality.
